(19) United States
(12) Patent Application Publication
(10) Pub. No.: US 2002/0046341 A1
(43) Pub. Date: Apr. 18, 2002

(54) System, and method for prepaid anonymous and pseudonymous credit card type transactions

(76) Inventors: Alex Kazaks, LaCrosse, WI (US); Sterling Garretson, Redmond, WA (US); Drew Bamford, Seattle, WA (US); Chris Prosise, Cupertino, CA (US)

Correspondence Address: Gray Cary Ware & Freidenrich LLP, 3340 Hillview Avenue, Palo Alto, CA, 94304-1203, US

(21) Appl. No.: 09/794,688

(22) Filed: Feb. 27, 2001

Related U.S. Application Data
(60) Provisional application No. 60/185,272, filed on Feb. 28, 2000.

(51) Int. Cl. H04K 1/00; H04L 9/00

(52) U.S. Cl. 713/182; 713/172; 713/183; 713/184; 713/185; 713/200; 713/201; 713/202; 380/227; 380/228; 380/229; 380/231

(57) ABSTRACT

Method and system for issuing and using anonymous and pseudonymous prepaid payment cards through the existing credit card and debit card infrastructure.

### FIELD OF THE INVENTION

The invention relates to pre-paid payment cards, virtual or real, in which the identity of the bearer may be real, anonymous, or pseudonymous.

### BACKGROUND OF THE INVENTION

In order to buy items from merchants today, it is often convenient or even necessary to avoid using cash. In many instances, it is not possible to complete a transaction using cash. For example, in order to secure a hotel reservation over the telephone, a valid credit card number usually must be given to the hotel. In the growing Internet economy, cashless transactions are the norm. To effectively participate in the Internet economy, a consumer must be able to pay for items by sending the Internet merchant some data that allows the merchant to electronically collect payment. Although it may be possible to send an Internet merchant a check for items purchased, the convenience and efficiency of the Internet transaction for both the consumer and the merchant would be lost.

Even credit cards have a disadvantage in the Internet economy. Many credit card holders are reluctant to give personal credit card information on the Internet. This is generally thought to be because they fear fraudulent use of their credit card, or even identity theft.

Some mechanisms exist for addressing the challenge of enabling cashless purchasing without credit cards. Bank debit cards allow a bank account holder to make cashless purchases. One limitation of debit cards is that they are only helpful to those who own bank accounts. Another limitation of debit cards is that some users are reluctant to use them in Internet commerce. This is because the number on the face of a debit card potentially gives access directly to cash and the use of the card is not monitored by some servicing entity. Thus, if the debit card data were stolen, a bank account could be emptied before the theft was detected. In comparison, credit card issuers typically monitor use, flag abnormal activity, and deny suspect charges. If the credit card is stolen, it can soon be deactivated and the rightful owner may be able to reverse the charges made by the thief.

Other devices for cashless transactions are prepaid cards for purchasing particular goods or services. Examples include prepaid phone cards, mass transit fare cards, and copy machine cards. The card has a prepaid amount of money either encoded on its magnetic stripe or associated in a database with indicia encoded on its magnetic stripe. Such cards are typically proprietary; that is, they are typically merchant specific or application specific (a particular product, good, or service). Some cards can only be used in a very particular machine that can recognize it and deliver a very particular good or service. When the prepaid amount has been spent, the card is useless. Such prepaid cards generally cannot be used to shop for a variety of various goods or services in stores or on the Internet.

Companies such as RocketCash have attempted to solve the specific problem of teen online credit shopping by creating “online accounts” for teens. These simple accounts work on a declining balance. There are two problems with this approach: (1) parental involvement (and credit card number) is required to establish an account, and (2) the accounts are proprietary networks, allowing teens to shop only at sites that are affiliated with the company. In some cases, these accounts are active only on the company's own web site, to purchase a very limited selection of goods. No selection and parental involvement prevent this model from satisfactorily meeting the market demand. A significant disadvantage is that these solutions target only the kid/teen demographic group, and offer no solution for the greater adult population who are reluctant to use their credit card on the Internet.

Other single use credit cards that insulate the payee from the payer's financial data (and account access) include American Express's single use card, which requires the user to have an American Express account, and to reveal his or her identity. Thus, it is neither anonymous nor pseudonymous.

Other pre-paid Internet shopping cards such as Mon-e and Cybermoolah are similar in their approach to cards addressing the teen shopping problem. However, both companies rely on a proprietary system that limits the number of web sites where their cards are accepted.

The gift card is another alternative cashless shopping device that has limited capabilities. The typical gift card is sold in a brick-and-mortar store. It is used much like a gift certificate to buy goods, but only in that store. Most if not all gift cards are incapable of buying goods online, and they are limited in use to a particular retailer. One company, Swift Gift, sells gift cards that are co-branded with MasterCard. Swift Gift cards can only be purchased online or over the phone using a credit card. Swift Gift cards have several disadvantages. Swift Gift does not capture any valuable demographic or shopping information that may be useful to formulate targeted shopper services or advertising. Swift Gift cards are relatively expensive because revenue is mainly derived from high premiums charged over the face value of the card (for example, 8.5% premium on a $100 card and 27.8% on a $25 card). Another disadvantage is that there is typically a considerable lag time between ordering a Swift Gift card and actually receiving it in the mail. Thus, the Swift Gift card may not be used almost immediately for shopping.

One challenge to be overcome in enabling those without credit to shop electronically is that new, paperless transactions typically require a new or altered infrastructure for facilitation and approval of transactions. For example, in the case of a phone card purchased at a retail store, the retail store must have access to the proper activation and/or approval infrastructure. The retail store must have a properly configured point of sale (POS) device through which to swipe the phone card. This infers that the POS device is coupled to the proper network for approval of the transaction and activation of the phone card. Some retail stores already use multiple POS devices and software systems to accommodate multiple electronic transactions. A need exists for a new cashless instrument that can be introduced without altering or adding to hardware and/or software of an existing infrastructure.

A need also exists for a cashless payment instrument that is resistant to fraud and to identity theft.

### SUMMARY OF THE INVENTION

The method and system of the invention facilitate issuing, activating, and managing anonymous and pseudonymous negotiable stores of value, including prepaid payment cards. As used herein a prepaid payment card is a card with an initial store of value, which may be drawn upon. To be compatible with the existing credit card protocols, the prepaid payment card of the invention is one having a magnetic stripe or embedded microprocessor or otherwise capable of being read by an ATM machine or a Point of Sale machine, and encoded with a Visa, MasterCard, Discover, American Express, JCB, or the like account number. The accounts associated with the cards have an initial available balance of zero and are embossed with a provider's number. The cards are sold, for example, in retail outlets, and are associated with a Virtual Visa or other account number with the appropriate dollar balance.

The system and method support transmitting card purchase information (seller, date, amount tendered) to an associated card servicer's server (where the card servicer is a financial institution in the nature of a bank, providing conventional credit and debit card support services). The card servicer's server tests and determines the validity of the card and, if valid, declines the transaction because the account associated to the card has a zero balance or is otherwise flagged as “inactive” by the issuing bank or sponsor. A typical credit card servicing bank's server would record the merchant (here the card seller), time of decline, date of decline, reason for the decline (the card sponsor has not placed money in the card account) and an identifying number, as an account number.

The purchaser completes activation at the card sponsor's web site (where the card sponsor provides the anonymity/pseudonymity support and other value added features) by entering card identifying indicia and personal data which may be alias data, anonymous data, pseudonymous data, or actual data. In this way, the user can make purchases without exposing personal information.

When the purchaser enters anonymous or pseudonymous data, or otherwise triggers card activation and account authorization, the method and system of the invention create a fraud detection rule compliant pseudonymous identity for the anonymous or pseudonymous prepaid payment card. Associating street numbers to a set of index numbers does this; generating a random number, and matching the random number to a street number index number to recover a street number. To get a street name, the method and system associate street names to a set of index numbers, generate a random number, and match the random number to a street name index number to recover a street name. A similar method is used to generate a city/state/ZIP code set, where the method and system associate city/state/ZIP code sets to a set of index numbers, generate a random number, and match the random number to a city/state/ZIP code index number to recover a city/state/ZIP code. A similar method is used to generate an anonymous or pseudonymous phone number. The method and system described herein combine the recovered street number, street, city/state/ZIP code set and telephone number to generate a pseudonymous or anonymous cardholder identity.

The associated system for processing anonymous or pseudonymous prepaid payment cards, includes a sponsor server controlled and configured to communicate with the card issuer's server, for example, for receiving card purchase information including a card BIN, verifying authenticity of the card, declining an initial transaction because of zero balance, and recording the seller, time of decline, date of decline, and account number.

The sponsor server is programmed, controlled, and configured for a user to complete activation at the sponsor's web site by entering card identifying indicia; and entering personal or alias data. When this step is completed the sponsor's server is controlled and configured to transmit an initial balance to the issuing bank, and associate a name or alias to the card.

The sponsor server, which may be one or more physical servers, and one or more software applications, such as an authentication executable for logging users into the server, a registration executable for registering users and user aliases, an account maintenance executable for processing account charge information and account balance information to and from a database server, and an online transaction processing server to authenticate user access, collect registration data, and manage account information, along with a database server.

The method and system of the invention uses the existing credit card/debit card infrastructure for activation and transactions. Activation is a two step process. In the first step a clerk swipes the deposit card as if charging an amount to a regular credit card, and the transaction is declined with a special decline code sent back to the retailer. This decline creates a record that contains the location of the seller, the time and date, the account number, and the decline message that was returned. These steps use the existing protocol and hardware of the credit card industry and retail world.

Subsequently, the user logs on to the prepaid payment card's sponsor's web page or dials into the sponsor's CTI (computer telephony integration or “800 number”) function and enters his/her deposit code number or alphanumeric sequence (printed on the card). This code is run against the card sponsor's database associated with a BIN and account number, and these numbers are used to look up the transaction record of the account. If that record contains a decline of the right type, from the location that the card was shipped to, the account is activated and the associated value is loaded. The user fills in his or her personal information, including anonymous or pseudonymous information via the web, CTI center, or other channel.

To prevent fraud, in one embodiment, a plastic card, or other card associated with the account, with a magnetic stripe is securely packaged for display in a retail location. The card may be purchased in various denominations. The card purchaser may use the card or a card associated with the purchase of the card to purchase items over the Internet. According to the invention, the card is activated for use by a two step process beginning at the time of purchase, and continuing through a post-purchase registration. Activation is accomplished by using an existing financial infrastructure including an existing binary identification number (BIN). In one embodiment, the card is registered at the web site administered by the sponsor of the card. In an alternative embodiment, the card may be registered over the phone. Registration of the card includes associating a credit card account number to the card. The number is of the type assigned by major credit card companies, for example VISA. The account number, either directly or indirectly through a database look up, identifies an account being one that is to have a balance matching the denomination of the card. After registration, the card may be used in the same manner as a credit card until the money in the account is exhausted, at which time it may, optionally, be “recharged.” The account is held and paid by the issuer of the card of the card.

A further aspect of the invention are the anonymity and pseudonymity aspects, by which the user can avoid disclosing or exposing financial or personal data. A further aspect of the anonymity and pseudonymity is the method and system of generating addresses and phone numbers to support anonymity and pseudonymity.

The invention further provides an alternative method of creating a pseudonymous identity for a holder of a prepaid payment card where the card and the holder are associated with an entity, and the card is a business card. In this case, the pseudonymous identity serves to identify the entity, the employee or sub-entity, and, optionally, the serialization of the card to the employee or sub-entity. This may be done by concatenating a first alphanumeric associated with the entity with a second alphanumeric associated with a user.

Also described are various methods for targeted advertising that may be implemented using the card sponsor's database, including such database entries as the present stored value of the associated account, the merchants where the card has been used, or the goods or services purchased through the account. This data may be collected and evaluated to present the account holder with targeted advertising.

Closely related are a method and system for rewarding users of payment cards who are participating in multiple promotional activities. This includes, at the sponsor's backend, searching a database associated to the payment cards and containing purchase history data, assigning a value to qualifying purchases at participating merchants, and associating the value to the card user. The points, miles, or award items can be applied to an account associated with the payment card and a data field (as defined in the metadata) associated with the merchant promotion. That is, the values associated to purchases can be collectively aggregated to an account, or can be individually stored and identified to an individual merchant and the user's activity with that merchant. An individual merchant's participation in the promotion campaign can be dynamically started and stopped

Also described herein is a method for managing the aggregation of funds from various sources to facilitate a particular purchase. This is carried out by transferring value to an account or to a temporary, occasion or purchase-specific virtual account.

The method and system of the invention facilitates electronic person-to-person electronic payment. This is accomplished by payer electronically identifying a payee, and a source account of the funds to the payment card sponsor. The sponsor sends a message fragment associated to the source account and identifying the payer, the payee, and the amount to be paid. This message fragment can be a hypertext link, or financial data, and it can be in the plain or encrypted. The payee uses the message fragment to request payment from the payment card sponsor. Person to person payment may be carried out in a system having a communication server, an application server, and a database. The system receives an electronic request for payment to a payee, from an identified source account of the funds associated to the payer. The system sends a message fragment identifying the source account, the payer, the payee, and the amount to be paid. Thereafter, the system receives a response to the message fragment from the payee; and issue payment or payment instructions to the payee.

### The FIGURES

The invention is illustrated in the figures appended hereto.

FIG. 1 is a diagram of a system overview according to one embodiment of the invention, illustrating the sale, point of sale activation, and sponsor web site authorization of a card according to the invention.

FIG. 2 is a block diagram of the method of buying the card, activating and authorizing the card, and shopping with the card.

FIG. 3 is a flow diagram of an embodiment of prepaid payment card activation through purchasing and validity checks to final authorization.

FIG. 4 is a block diagram of an architecture of the sponsor site according to one embodiment.

FIG. 5 is a screen shot of the virtual prepaid payment card.

FIG. 6 is a screen shot of the tool bar and the explorer bar with an e-merchant (Amazon.com) page in the image area.

FIG. 7 is a screen shot of the deskband, which functions similarly to the Tool Bar.

FIG. 8 is a screen shot of the “Edit Info” screen, which allows the user to enter and edit their information.

### DETAILED DESCRIPTION

As used herein, the “issuer” is the bank or financial institution providing transactional support for a credit card, as receiving point of sale swipes and making debit and credit entries, and the “sponsor” is the institution performing the pseudonymity/anonymity services, marketing and targeted marketing support, promotional services, and the like. According to the invention, a card, as a virtual card or a real plastic card is purchased at a retail location and the purchaser is enabled to use the card in a way analogous to a credit card without the need for the user to qualify for a credit card or for any changes to be made to an existing banking/credit card infrastructure. Activation and authorization/registration are explained more fully below

The system and method described herein have as their core goal—to keep processing as timely and robust as possible and to leave fulfillment and card use issues to the entities out side of the sponsor's domain, while providing accessibility, anonymity or pseudonymity, and safety to the user. The system has a web site and/or a CTI (computer telephony integration) that supports the prepaid payment card process. In the case of a Web site, the site offers a graphical user interface to the user. This web interface lets the user register, log in, activate their card, and then manage their account (essentially see their account balance). This interface also has a number of other functions and features, such as collecting demographic data and presenting targeted marketing using a profiling approach. This user interface will be built using HTML and JHTML.

In one embodiment, a conventional credit card type plastic card with a magnetic stripe is securely packaged for display in a retail location. The card may also be sold over the phone and from a web site. The card looks like a credit card, debit card, ATM card, or check card. In various embodiments, the card may be imprinted with any combination of the name; the logo of the servicing credit card company; or the sponsor; a private label binary identification number (“BIN”); another credit card BIN number; a credit card number, and a magnetic stripe printed on the card or a microprocessor embedded in the card. The magnetic stripe or microchip is encoded with a form of credit card account number or another number for which an infrastructure exists.

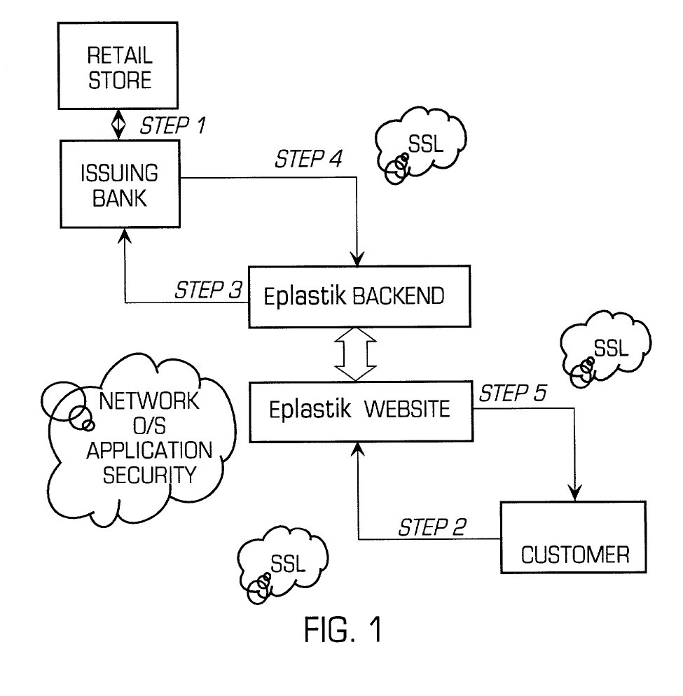

FIG. 1 is a diagram of a system according to one embodiment of the invention. FIG. 1 illustrates the activation and registration of a prepaid payment card for use in shopping, such as on the Internet. The system uses the existing infrastructure as shown in FIG. 1. Specifically, the customer buys the card, and the clerk swipes the prepaid payment card as if charging an amount to a regular credit card, 11. The transaction is declined by the bank, 13, and a special decline code is sent back to the retailer, 11. This decline creates a record that contains the location of the store, the time and date, the account number, and that the decline message that was returned, 15. This is accomplished within the existing credit card processing protocol, software, and hardware. Next, the user returns home and logs on to the web site of the card sponsor, illustrated as “Eplastic.com” 17. The customer enters his or her deposit code number or other alphanumeric (printed on the card), 18. This code is run against the database, 15, where it is associated with a BIN and account number, and these numbers are used to look up the transaction record of the account. If the record contains a decline of the right type, from the location that the card was shipped to, the account is activated, and the associated value is loaded 19. The user fills in his or her personal, anonymous, or pseudonymous information via the web.

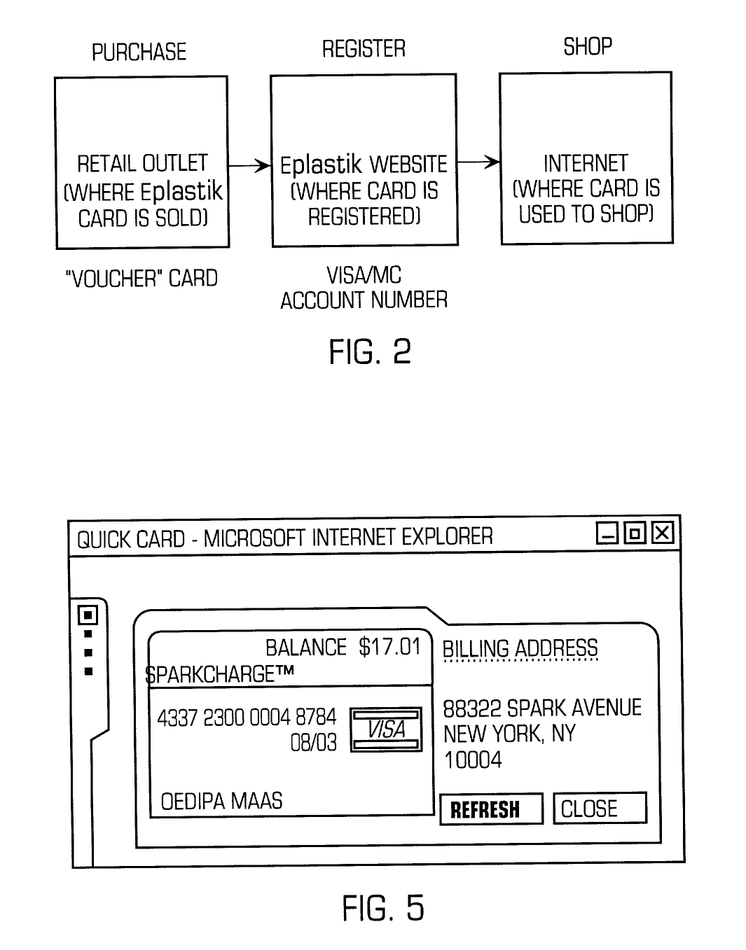

FIG. 2 is a block diagram of the card purchase, activation, and registration according to one embodiment of the invention. The card is purchased at a retail location, 21, where it is partially activated (by receiving a “decline” when swiped through a reader). The card is then registered at the sponsor's web site, 23. After registration, the card may be used to shop anywhere on the Internet, 25.

A BIN is a two-part code assigned to banks and savings associations; the first part shows the location and the second identifies the bank itself. The BIN is also known as a Bank Identification Number or an American Bankers' Association transit number. As used herein, a BIN is a number that can be assigned to a service voucher or financial instrument and read by a point of sale (“POS”) machine. The BINS typically tell the POS terminal where to call to activate a card and which card is to be activated. Each POS terminal has several recognized families of BINS, for example, one series for Visa cards and another for MasterCard cards being two examples. According to the invention, rather than implementing a proprietary system for activation, an existing BIN protocol is used for activation. A BIN within the BIN protocol is issued to a prepaid payment card. This BIN corresponds to a BIN family already in place in the retail infrastructure. For example, the BIN may be in the BIN protocol associated with a stored value Visa card. To be noted is that there may be one number associated to the card, e.g., for activation, and another number associated to the account. This card is assigned a low value by the servicing entity, preferably a balance of $0, or a status of “inactive” or other status indicative of an account that has not yet been activated. When a customer buys the card, its protective packaging is removed and a charge is attempted against the card by swiping it through a POS terminal. This initial charge is declined, as the available credit balance is zero. The card is intentionally declined for the purpose of creating a record of the purchase of the card at a particular location to which it was shipped. From the record thus created the sponsor can see that the prepaid payment card was paid for, swiped, and declined at the location to which it was shipped. This information is interpreted to cause activation of the purchased prepaid payment card.

In another embodiment, the initial balance in the account and the amount charged against it may each vary for purposes of security. The initial balance may be a function of a secure algorithm that relates the card number with its initial balance or a simple indicator of the card's denomination, or some other information. The amount charged may be encoded in an accessible bar code, price tag, or other system for billing. Packaging protects this barcode from discovery by anyone other than the activating clerk, as is described below.

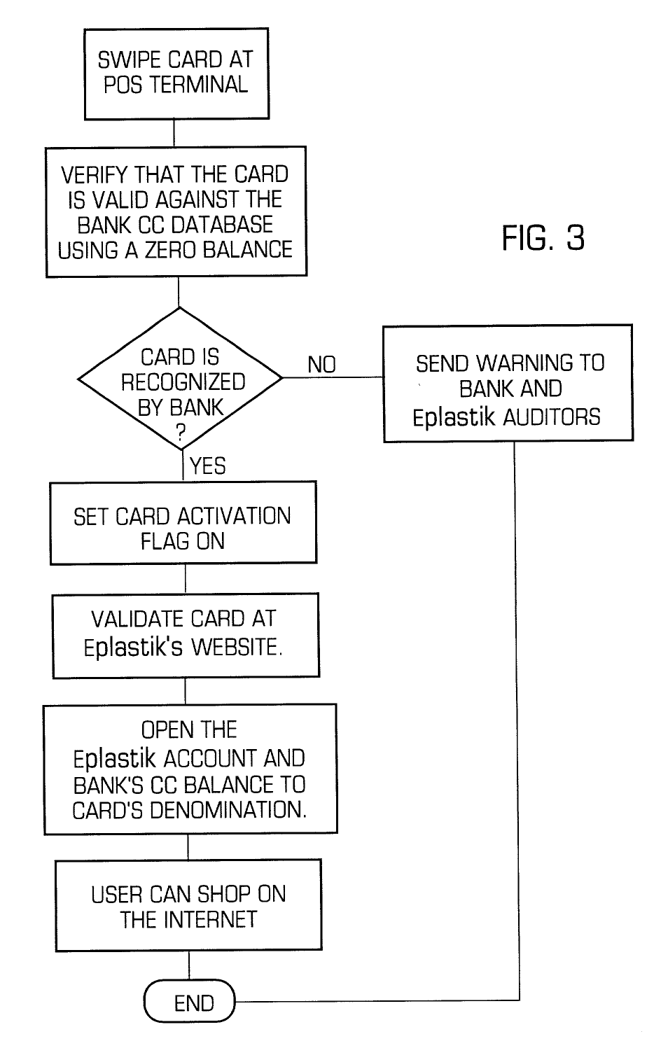

FIG. 3 is a flow diagram of one embodiment of card activation and registration. The customer purchases the card from the retail outlet. The retail clerk swipes the card in their POS card reader, 301. This checks the account number at the credit card servicing company/bank using an existing BIN type, 303. If the card number is invalid, 305b, an error code is returned, and the card is not sold. An alert is sent to the servicing credit card carrier (bank) and provider for fraud investigation, 321. If the card account is valid, 305a, a valid code is returned but with a zero balance for that card account, thus setting the card activation flag, 307. The magnetic strip may also contain information regarding the store location selling the prepaid payment card; this would ensure that cards shipped to a particular location are sold and activated at the proper location. This prevents the possibility of fraudulent use of stolen cards, counterfeited cards, or hackers trying to use the credit card numbers.

In addition to, or instead of, purchasing the card at a store or other retail outlet, the purchaser can purchase the card by mail order, over the internet, at an automatic teller machine or dedicated kiosk, or over the telephone. Likewise, the card can be “recharged” by mail, over the Internet, by telephone, from another credit card, or by an electronic fund transfer. In this regard, the account can be established, activated, charged against, recharged, and closed over the Internet, over the telephone, by mail, or in person.

The account associated with the purchased prepaid payment card is not opened or credited with the card's denomination until the user visits the sponsor's web site, 309. The user accesses functionality of the web site with a user name and user identification. At the web site, the user may fill in user demographic data, including anonymous or pseudonymous data, and registers the card. The user types in the account number embossed on the card, and a web site application checks to determine if the card has been swiped and the account has been established. If the account exists, but is set to zero with a first time activation code set, the activation at the store is validated, 311. If the activation at the store is validated, the user is given a new, preferably different and separate, account number that is then used as the card number for shopping. The new account number is a compatible account number from a set of existing but unassigned numbers defined by the credit card company, e.g., VISA. The account number is one of multiple compatible and unused BIN numbers in a set of existing BIN numbers identifying “private label cards” assigned to the sponsor by a servicing bank. This is to be distinguished from a proprietary card such as those associated with a single merchant, although the method and system of the invention could be used with a single merchant card, for example, a gift card. The account number is associated with a charge card account “belonging” to issuer that looks and behaves exactly like any other typical charge card account with the exception that it has a finite balance to be drawn from. The account balance of the new account is set to the full denomination amount indicated on the card as sold in the store. The user can now shop on-line, 313, and the credit card account acts just like a regular credit card until its balance reaches zero. Then an invalid code is attached to that card and account, 315. To be noted is that the account can be “recharged” with transfers from another account, another credit card account, a check, an electronic check, or an electronic fund transfer.

In some embodiments, the BIN used for activation may be the same BIN associated with the account that is credited with the card denomination at registration. In yet other embodiments, the BIN used for activation is not an existing BIN type. For example, the activation BIN may be an ISO BIN, while the registration BIN may be a private label BIN. A new infrastructure will typically be required, however, to process ISO BINS.

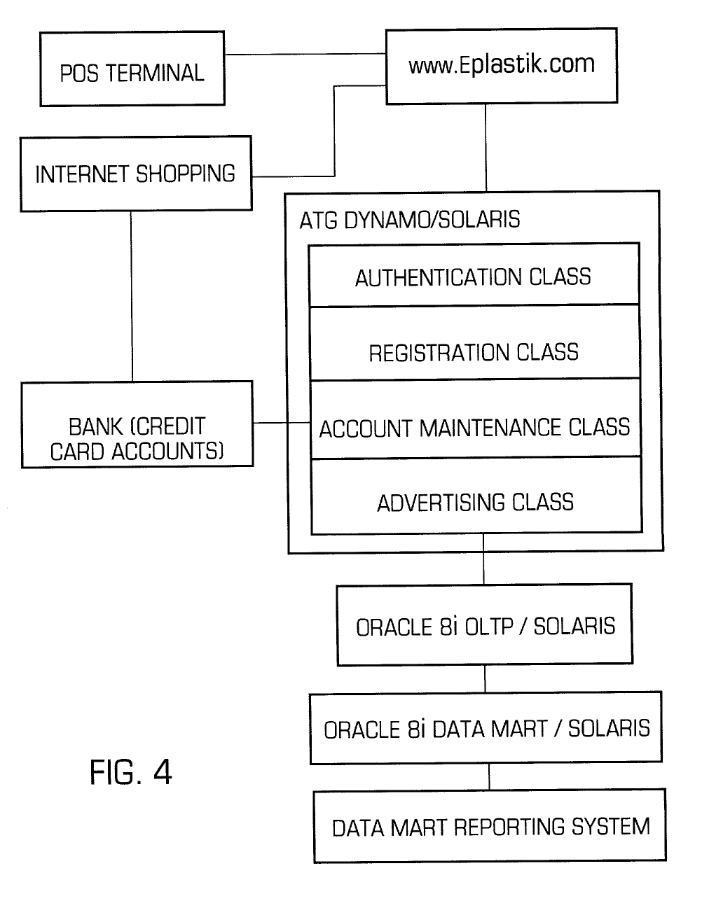

FIG. 4 is block diagram of transaction processing according to one embodiment of the invention. A number of computer servers communicate with two external data sources, the POS terminal, 401, and a servicing bank's credit card account processing system, 407. Users of the card described herein also shop on the Internet, 405. The POS terminal, 401, the bank's system, 407, and the systems accessed during Internet shopping, 405, are generally entities external to the system that administers the prepaid payment card system and web site, 403. An achievement of the system is timely and robust processing of transactions. This is facilitated in part by the virtual separation of fulfillment and card use issues, which are handled exclusively by the entities outside of the prepaid payment card domain. The prepaid payment card system includes a web site, 403, with a user interface. The user interface lets the user log in, register, activate their card and then manage their account (for example, see their account balance). The user interface also has a number of other functions and features, such as collecting demographic data and presenting targeted marketing using a profiling approach. In some embodiments, the user interface comprises hypertext markup language (“HTML”) and JHTML.

The user interface makes calls to Java servlet programs, or other executables, hosted by an application server, 411. Various executable files perform different functions. For example, a user authentication executable file, 413, logs users onto the site. A registration executable file, 415, allows users to register for a user identification and password and to input user demographic data, such as anonymous data or pseudonymous data. The account maintenance executable file, 417, allows users to view the balance on their account, and the advertising executable file, 419, formulates and sends targeted advertising media such as banner ads and special offer coupons to the user.

The account maintenance executable file, 417, communicates with the credit card servicing bank, 407. This executable file, 417, is responsible for keeping the account balance up to date.

In one embodiment, there are two database functions. The online transaction processing database, 421, is used to authenticate, collect registration data, and manage currently active accounts. The historical reporting data mart, 423, is used to report on historical user trends and other information that is valuable for reporting. For example, the data mart may be used to generate valuable “shopographic” data, through a datamart reporting system, 425. This could all be in one database, and the database or databases could also be used in support of promotional activities, as well as support of directed marketing.

In one embodiment, the system includes functionality and database metadata (as additional data fields for temporary pseudonyms, temporary links, and enumeration of the sources of the funds) that allows several individuals to contribute specified dollar amounts toward a single group purchase. This could be used for major purchases, gifts, group purchases, group gifts, or the like. In one embodiment, a user may use email to solicit the individual payments from the members of the group involved in making a purchase, a donation, a reservation, etc. Each individual payment toward the total transaction amount is made by visiting the site and entering the individual's source credit card account number and the group's target credit card number. The site then charges the source credit card the specified amount and holds all “partial payments” until the total transaction amount has been achieved, at which point the transaction is executed and the site makes payment on the transaction. If the total transaction amount is never reached, the partial payments are credited to the respective accounts.

This feature is a business and technical methodology by which several individuals or one individual with several cards (as where the purchase price exceeds the value of any single card) can contribute specified dollar amounts toward a single group purchase. The web site uses email to solicit the individual payments from the members of the group involved in making the purchase/donation/reservation/etc.

In this aspect of the invention, which is a method of aggregating funds into a prepaid payment card account, a participant, such as the owner of the prepaid payment card identifies a particular prepaid payment card account to receive the aggregated funds. The owner of the receiving payment card may then establish an identity for the account holder of the identified prepaid payment card account. This can be the account holder's actual, real identity, or an anonymous, or a pseudonymous identity, for example an identity identified with the purpose of the aggregation, such as “Parents'_Anniversary” or “Melissa's_Wedding” or the like. The next step is to authorize access to the prepaid payment card for the purpose of making payments into the prepaid payment card account. Last, the sponsor or the issuing bank or both must receive the payments into the prepaid payment card account.

Soliciting the money and authorizing access can involve assigning a user id and a personal identification number. In this case, the user id may be a BIN within a set of BINs supported by a sponsor of the prepaid payment card. Alternative, the user ID is selected by the owner of the prepaid payment card. In still another aspect of the invention, the person soliciting payments may include a hypertext link authorization for payment access.

An account owner can even aggregate his or her own funds to make a major purchase, for example by selecting his or her own account, and transferring money from his or her other prepaid payment cards into the selected account. In this way, the card can be used for major purchases. This can be also be a form of prepaid payment card “overdraft protection in that an account owner can specify other credit cards, prepaid payment cards, or the like to be drawn upon if a card becomes exhausted.

Aggregation of funds is carried out in a system having at least a data server, an application server, and a database management system. The system receives payments, including electronic fund transfers, credit card transfers, and payment card transfers, matches transfer information, such as user ids and account and BIN numbers, and transfers the money into the designated account. This may be accomplished at the sponsor's web site, or at a CTI (computer telephony integration) facility, using the standard methods of electronic banking.

A further aspect of the method and system described herein is a digital display of credit card account information for use in entering credit card data merchant check out forms. As shown in FIG. 5. Users of virtual credit cards need an easy way to reference their personal account information, including current account balance, 503, account number, 505, expiration date, 507, billing name, 509, billing address, 821, telephone number, and email address, 825, as they complete purchase forms at merchant Web sites.

Users may view their virtual payment card, 501, by pressing a button on the Account Overview or Shop pages of their account. When clicked, the button opens a new window via Javascript, and loads a dynamic page, which displays all of the user's billing information and their current account balance rendered in HTML. Users may copy and paste billing information from the quick card into the purchase forms on merchants' sites. Buttons on the Quick Card allow users to refresh the current balance and to close the window. Alternatively, the graphical user interface may include buttons, which link directly to the Deposit page of the user's account and to the Account Overview. See FIG. 5 for an example of a displayed virtual prepaid payment card.

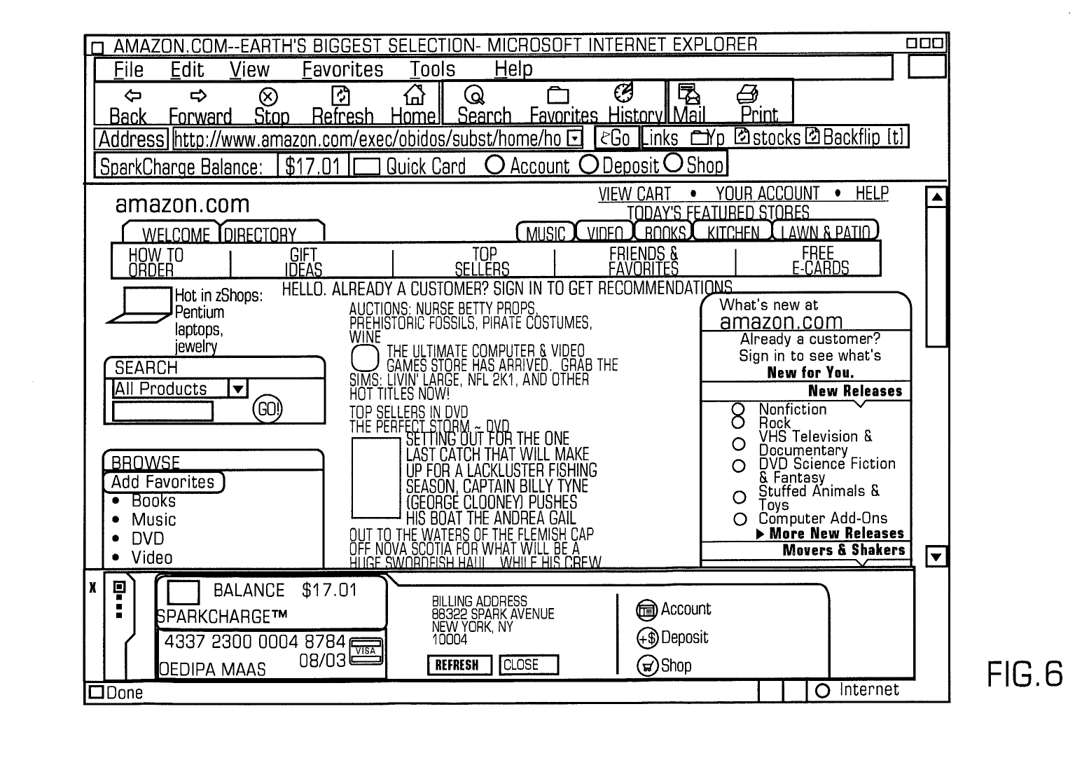

The tool bar, 601, and the Explorer Bar, 611, are shown in FIG. 6. This solution uses Internet Explorer's band object to create a toolbar, 601, which appears in the toolbar area of Microsoft's Internet Explorer Web browser. The toolbar, 601, displays the user's current prepaid payment card account balance, 603. The balance is updated over the Web on a pre-defined schedule. Also included are buttons that link directly to the user's Account Overview, Deposit page, and Shopping page. An additional button causes the Explorer Bar to open. FIG. 6 shows both the Tool Bar and the Explorer Bar.

The Explorer Bar, 611, is a horizontal child window, located below Internet Explorer's primary browser pane, 612. It contains the same information displayed in the Virtual Card Image Window, with the advantage that it is never obscured by the user's primary browsing window.

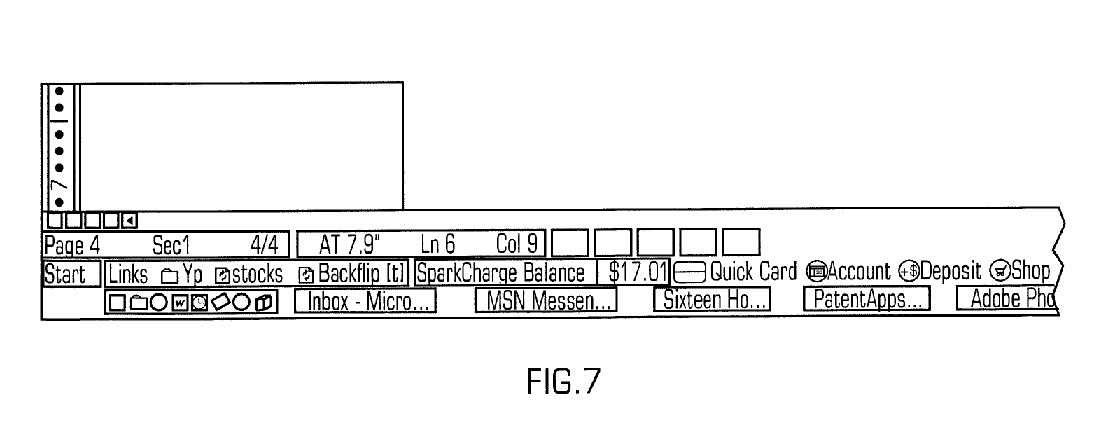

The desk band, element 701 in FIG. 7, functions similarly to the Tool Bar, except that it docks to the user's desktop task bar. Thus, the information and links on the Desk Band are available even when the user has no browser windows open

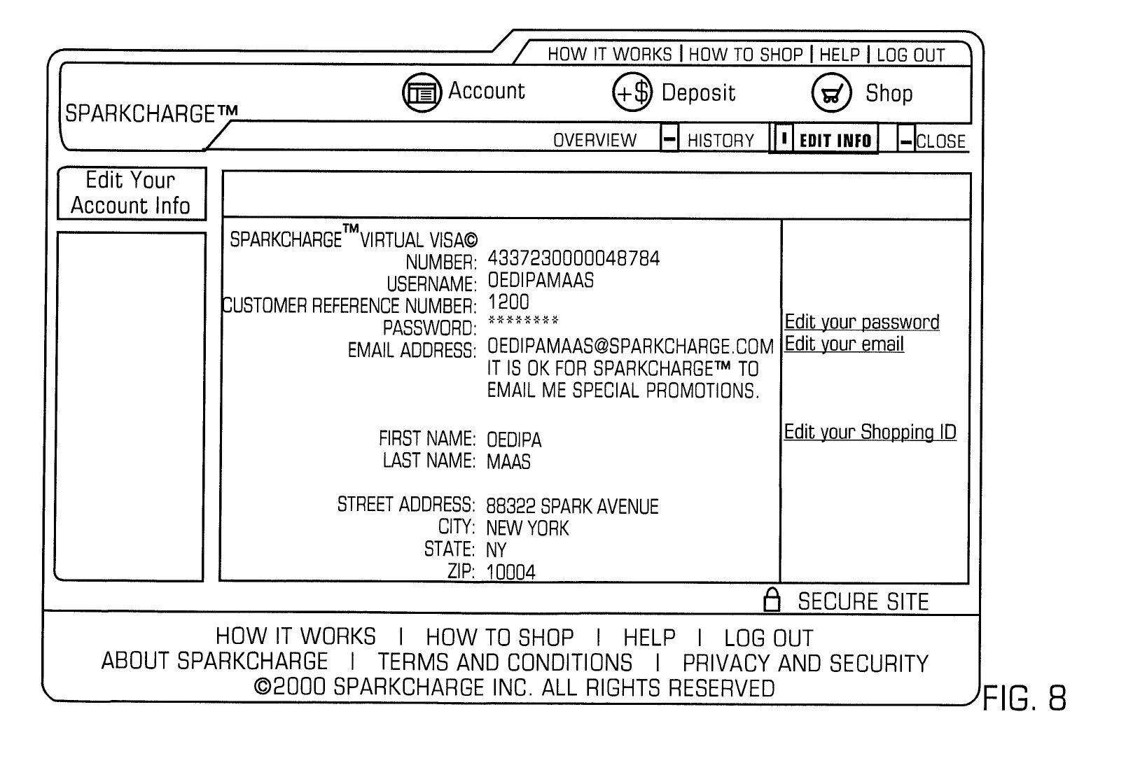

The method and system of the invention enables users to edit the information present in the credit card processor's database directly. This allows users to not only update their real personal information instantly, but to fabricate their own fictitious identities. See FIG. 8 for a screenshot of the ‘Edit Info’ section of the method and system described herein. Closely related to the “Edit Info” screen is a screen called the “Floating Credit Card” screen which gives a customer a complete view of his or her card activity for a particular account, or of all associated accounts.

Phantom Identity

The method and system of the invention provides full user control over the user's shopping identity. As noted above, 70% of Americans who use the Web rank privacy as their number one concern. Central to Web users' concerns regarding their privacy is their lack of control over what personal information is resident in the databases maintained by merchants and banking institutions.

It has been reported that seventy percent of Americans who use the Web rank privacy as their number one concern. While most Web users are concerned about being tracked, spammed and otherwise “used” by web sites and marketers, their core fear surrounds the security of their' personal financial information. It has also been reported that 65% of Web users are afraid to use their credit card online, resulting in billions of dollars in lost revenue online.

To address privacy and security concerns online, the sponsor generates a Phantom Shopping ID with pseudo-random data. This identity is comprised of the complete set of information required to shop or conduct other transactions online. Included are a name, credit card number, address, email, phone number, and other information, which may be used in conducting transactions. Unlike other forms of privacy protection like IP masking, this information is not merely offered up as a cloak, but stored in the databases used by third parties for verification. Thus, the user's true identity is not hidden, but rather, they are able to assume a complete alternate identity.

The Phantom system has several benefits to consumers. The primary benefit is that users can make financial transactions without disclosing any personal information. Second, the account created is known as a ‘stored value’ account, meaning there is only as much money in it as the user deposits. This limits the downside of a breech of security to a small amount of money, unlike a credit card or cash card, which may be attached to larger bank accounts or credit limits. A stored value account can be funded by purchasing a pre-paid card, transferring cash through electronic check payment, or by using an existing credit card. Third, the account has no personal information associated with it. Any account that must be opened through a credit application-like process captures sensitive personal information, which may be used to commit identity theft, or otherwise compromise the privacy of an end user. Finally, identities that are generated are more secure than those that are populated with real user information. In other words, when users set up accounts using their personal information, they are populating the data fields used to verify their identity with information that is available on countless other documents, such as the phone book, mail, and checks. This information is more easily obtained and used to impersonate the account owner than information that is randomly generated and assigned to the account owner. In effect a phantom identity acts as a large and difficult to guess password.

A critical component of a complete online Phantom identity is a complete, verifiable, set of credit card “billing” information. Ninety seven percent of all online transactions are completed with a credit card, and each of these requires a name, billing address, phone number, and, in most cases, and email address. In order to verify that the purchaser is a legitimate account holder, the merchant passes the billing information through one or two filters. The first filter is AVS, or address verification. It is used during a card-not-present transaction to check that the prospective customer's account number, name, and address match those in the card processor's database. While this provides some protection against fraud, many sites run additional “fraud screen” software. The fraud screen software goes beyond checking a few facts against the card processor's database. It checks for aberrant information, risk factors, and suspicious account histories. The information used for these checks includes telephone numbers, area codes, emails, and more. These fraud screens are becoming more and more common, making fabrication of a phantom identity that will pass the screening process increasingly difficult.

The method and system described herein brings to bear a detailed understanding of the fraud screening process to carefully construct a random identity that will pass the most stringent fraud screen. The rules associated with generating the address data are governed and motivated by fraud screens in use for on-line shopping. Using pseudo-random data, the method and system of the invention fabricates a “billing address” for the user's prepaid payment card account, and populates the card processor's database with the randomly generated address. The method and system of the invention use rules associated with generating addresses governed by fraud shields used to detect frauds in on-line shopping. The anonymization/pseudonomization process starts from a set of random numbers to generate a street numbers. A set of street names is associated with a set of numbers, and the street name is selected by matching a random number to the number associated to a street name. Next, a set of city/state/ZIP codes are associated with a set of random numbers, a city/state/ZIP is selected by matching a random number to an associated city/state/ZIP. These same methods could also be used to generate an anonymous or pseudonymous telephone number. These methods are illustrated in the code blocks shown below, which generate the pseudonymous street address and city/state/ZIP code. This is accomplished by, for example, the code show below

//------------------------------PRIVATE METHODS----------------------------------
/**
* Private method which generates a random billing street
*
* @exception PeristenceException thrown by the UserManager and associated classes

| | |
|---|---|
| * | if database is down during retrieval of random streetAddress |
| * | |
| */ | |

private void generateAddress() throws PersistenceException {
// Generate house number
int houseNumber = (int)((Math.random()*99999) + 1);
// Generate street
Street streetArray[] = mStreetMgr.retrieveAllStreets();
int streetID = (int)((streetArray.length*Mathrandom()));
Street pStreet = streetArray[streetID];
userStreet.setAddress1((new Integer(houseNumber)).toString() +“”+
pStreet.getAddress1());
userStreet.setAddress2 (EMPTY_STRING);
}
/**
* Private method which generates a random billing city/state/zip
*
* @exception PeristenceException thrown by the UserManager and associated classes

| | |
|---|---|
| * | if database is down during retrieval of random cityStateZips |
| * | |
| */ | |

private void generateCityStateZip() throws PersistenceException {
// Generate city/state/zip
CityStateZip cityStateZipArray[] = (CityStateZip[]) mCityStateZipMgr.retrieve();
int cityStateZipID = (int)((cityStateZipArray.length*Math.random()));
CityStateZip pCityStateZip = cityStateZipArray[cityStateZipID];
userCityStateZip.setCity(pCityStateZip.getCity());
userCityStateZip.setState(pCityStateZip.getState());
userCityStateZip.setZipCode(pCityStateZip.getZipCode());
}
}

Alternatively, the sponsor's address and phone number could be used. Additionally, the account can be identified to any address and phone number by a merchant or a fraud detector as valid.

According to another embodiment of the invention, the pseudonymous identity can be assigned to a business entity, for further breakdown and assignment to employees for corporate purchases, such as office supply purchases, travel, entertainment, and the like. Thus, the pseudonym could include an identifier associated to the entity, an employee or department, and a serial number (as the nth card issued top this employee), for example “IBM.043113.005” would be the fifth card issued to IBM employee with the employee number 043113.

In this embodiment, the invention provides an alternative method of creating a pseudonymous identity for a holder of a prepaid payment card where the card and the holder are associated with an entity, and the card is a business card. In this case, the pseudonymous identity serves to identify the entity, the employee or sub-entity, and, optionally, the serialization of the card to the employee or sub-entity. This may be done by concatenating a first alphanumeric associated with the entity with a second alphanumeric associated with a user; and recording as the address and telephone number, an address and telephone and telephone number associated with the user or the entity. Where the “user” is a sub-entity, the alphanumeric is a sub-entity associated alphanumeric, and where the “user” is a person, the alphanumeric is an employee associated alphanumeric.

In the step of concatenating a first alphanumeric associated with the entity with a second alphanumeric associated with a particular user, the alphanumeric may further includes an alphanumeric associated with the sequence of the card assigned.

In another embodiment, very focused targeted advertising, based upon, for example, amounts purchased or purchase patterns, is enabled by the system. It must be noted that a card holder must be given to absolute right to opt out of marketing arrangements, or more precisely, be given the opportunity to affirmatively opt into such arrangements, where the default is opting out. Accounts of any type have either a certain balance remaining on their pre-paid, fixed value instruments or a remaining amount of credit before reaching a credit limit. This is true of web-based accounts as described herein, as well as accounts administered by traditional financial institutions such as gift cards, stored value cards, pre-paid cards, debt cards, etc. This remaining balance is easily measured by the servicing financial institution or any entity that has access to account balance/available credit limit information. Account holders themselves may also access this information. These balances offer a unique advertising opportunity to present account holders with purchasing options that correspond to the amount of money they have available on the instrument. Essentially, potential shoppers may be informed about what specific items could be bought with an available balance. The options presented may depend upon an advertiser paying a fee for listing suitably priced products or services to be offered.

One form of targeted advertising is balance-based targeted advertising. The balance or available credit remaining is easily measured by the servicing financial institution or any entity that has access to this (account balance/available credit limit) information, and may be accessed from time to time by the account holders themselves. These balances offer a unique advertising opportunity. Account holders may be presented with purchasing options that correspond to the amount of money they have available on the instrument. Essentially, potential shoppers could ask, or be told, “What could I buy with my available balance?” The options presented would depend on advertising paying a fee for listing their suitably priced product or service to be offered.

Account behavior-based advertising analyzes the types of purchases, and creates advertising based on the types of purchases. Given the accounts assumed above, and some knowledge of the historical purchases transacted by the account holder, one can understand the shopping habits of any particular account holder. If, for example, a particular account has been used to purchase sheet music, then, as pre-arranged by contract with advertisers, a dynamic marketing structure compares the offered payments of several different advertisers for a consumer meeting the profile in questions and the advertising space is awarded to the highest bidder. While this type of targeted advertising has been discussed, it is this dynamic auctioning process of ad spots based on alignment with account transaction history that we seek to patent.

Competitive advertising is a form of advertising where the database is used to determine who the card holder has purchased from, and make a list of such card holders available to the sellers' competitors. If an account holder is known to have purchased the goods or services of Company A, Company B may contract with the advertising entity to advertise their competing goods or services to the account holder already demonstrating a historical (purchasing) relationship with Company A.

According to one embodiment, competitive advertising allows an advertiser to access a consumer who has already completed a purchase with a competitor for the purpose of persuading the consumer to purchase in the future with the advertiser. That is, if an account holder is known to have purchased the goods or services of Company A, Company B (the advertiser) may persuasively advertise their competing goods or services to the account holder who has already demonstrated a purchasing relationship with Company A.

Cash back and frequent shopper programs are an extension of targeted marketing programs. Similar to those applications and functionalities, the cash back and frequent shopper programs use shopographic information to generate customer retention and rewards programs. In these cases the method and system of the invention retroactively evaluate behavior and use data and records to give cash back or other types of rewards. For example, after advertising $5 back on any purchase at Target the method and system of the invention can search associated databases to find those who bought at Target during the period of the offer using the prepaid payment card of the invention and credit their account five dollars. Additional logic may be applied, targeting those who are first time shoppers at Target, for example. This is easily scalable and extensible into frequent shopper programs in which repeat shopping is rewarded in a number of ways. Unlike conventional credit cards, the method and system of the invention run more than one loyalty or affinity program at once. One could be, for example, a Ford, a Goodyear, and a Target frequent shopper at once—participating in each of their programs separately, and receive rewards from one prepaid payment credit card for doing so. Finally, the method and system described herein allows joint frequent shopper programs to be formed. For example, customers could get $10 with each $300 spent at the GAP or Amazon in any combination. Promotions can be initiated, suspended, terminated, or suspended using the method of the invention. (For example if a customer were to spend $100 at Amazon and $201 at the GAP, they would receive $10).

The method and system for rewarding users of payment cards who are participating in multiple promotional activities includes, at the sponsor's backend, searching a database associated to the payment cards and containing purchase history data, assigning a value to qualifying purchases at participating merchants, and associating the value to the card user. Where there is more then one participating merchant, the assigned value is applied to an account associated with the payment card and a data field (as defined in the metadata) associated with the merchant promotion. The payment card is a preferably a prepaid payment card, although the invention is applicable to other cards as well.

An individual merchant's participation in the promotion campaign can be dynamically started and stopped. Additionally, the values associated to purchases can be collectively aggregated to an account, or can be individually stored and identified to an individual merchant and the user's activity with that merchant.

According to the invention, access may be had not only to account balances, but also to detail regarding what was purchased and when. This allows for account behavior-based advertising. With knowledge of the historical purchases transacted by the account holder, which can be found in the sponsor's database, the sponsor can understand the shopping habits of any particular account holder. Consumers may be profiled in detail from their behavior as recorded in the consumer's online account. Access to specific groups of profiled consumers is very desirable to most companies selling particular products. Thus, in one embodiment, consumer profile information is collected and “auctioned” to the highest bidding advertiser. For example, Internet banner advertising to a particular consumer may be auctioned in near real time as the consumer shops.

Sending person-to-person (P2P) payments typically requires users to type in the email address of the recipient. This is an inconvenient and unnecessary step, given than many users have a list of their most frequent contacts available in the form of their instant messenger contacts list. The method and system of the invention is efficient, fast, uses prepopulated and preformatted messages, and a pre-existing system

Integration of the prepaid payment card of the method and system described herein into existing instant messaging applications, such as MSN Messenger Service, AOL Instant Messenger, and Yahoo Messenger, is an easy way to make P2P payments more efficient and convenient. A right click on one of the contacts in the user's contact list, or selection of a menu item, enables the user to specify the recipient of the payment quickly and easily. The P2P form at the card sponsor's (or the IM integration partner's) Web site opens immediately (pre-populated with the contact's email address), allowing the user to quickly specify the amount of the payment and confirm the transaction.

The method and system of the invention facilitates electronic person-to-person electronic payment. This is accomplished by payer electronically identifying a payee, and a source account of the funds to the payment card sponsor. The sponsor sends a message fragment associated to the source account and identifying the payer, the payee, and the amount to be paid. This message fragment can be a hypertext link, or financial data, and it can be in the plain or encrypted. The message fragment can be sent to the payer—for forwarding to the payee, or directly to the payee. The funds may be segregated upon issuance of the fragment, and transferred upon presentation of the fragment. The payee uses the message fragment to request payment from the payment card sponsor. Generally, the source account is associated to a payment card, such as a prepaid payment card.

Person to person payment may be carried out in a having a web server or other communication server, an application server, and a database. The system receives an electronic request for payment to a payee. Payment is from an identified source account of the funds associated to the payer. The system sends a message fragment identifying, or associating within the system, the source account, the payer, the payee, and the amount to be paid. Thereafter, the system receives a response to the message fragment from the payee; and issues payment or payment instructions to the payee.

A further aspect of security is the packaging of the card at the retailer's. The card packaging is tamper evident and prevents “dipping,” that is, unauthorized access to the magnetic stripe. The packaging obscures any code numbers, and generally protects the card's security system from being compromised.

While the invention has been described with respect to certain preferred embodiments and exemplifications, it is not intended to limit the scope of the claims thereby, but solely by the claims appended hereto.

We claim:

1. A method of activating an anonymous or pseudonymous prepaid payment card comprising the steps of:
a) transmitting card purchase information to an associated card servicer's server, said card servicer's server determining the validity of the card and, if valid, the activity of the account associated to the card, and recording the seller, time of decline, date of decline, and account number;
b) activating by entering card identifying indicia and personal data chosen from the group consisting of alias data, anonymous data, pseudonymous data, or actual data;
whereby the user can make purchases without exposing personal information.

2. The method of claim 1 wherein the servicer's server determines the validity of the card.

3. The method of claim 1 wherein the servicer's server determines the activity of the account associated to the card by a zero balance.

4. The method of claim 1 comprising activating the account associated to the card at the sponsor's web site.

5. The method of claim 1 wherein the purchaser enters anonymous or pseudonymous data and where the method further comprises creating a fraud detection rule compliant pseudonymous identity for the anonymous or pseudonymous payment card comprising the steps of:
a) associating street numbers to a set of index numbers, generating a random number, and matching the random number to a street number index number to recover a street number;
b) associating street names to a set of index numbers, generating a random number, and matching the random number to a street name index number to recover a street name;
c) associating city/state/ZIP code sets to a set of index numbers, generating a random number, and matching the random number to a city/state/ZIP code index number to recover a street number;
d) combining the recovered street number, street, and city/state/ZIP code set to generate a pseudonymous or anonymous cardholder address.

6. The method of claim 1 wherein the “inactive” indicia is chosen from the group consisting of a zero balance and a sponsor assigned code.

7. A system for processing anonymous or pseudonymous prepaid payment cards, said system comprising a sponsor server controlled and configured to communicate with:
a) a card issuer's server for receiving card purchase information including a card BIN, verifying validity of the card, declining an initial transaction because of zero balance, and recording the seller, time of decline, date of decline, and account number; and
b) the sponsor server being controlled and configured for a user to complete activation at the issuer's web site by the steps of
i) entering card identifying indicia; and
ii) entering personal or alias data; and
iii) the sponsor server controlled and configured to thereafter transmit an initial balance to the issuing bank, and associate a name or alias to the card.

8. The system of claim 7 wherein the sponsor server comprises one or more of:
a) an authentication executable for logging users into the server;
b) a registration executable for registering users and user aliases;
c) an account maintenance executable for processing account charge information and account balance information to and from a database server;
d) an online transaction processing server to authenticate user access, collect registration data, and manage account information; and
e) a database server.

9. The system of claim 8 wherein the executables are chosen from the group consisting of classes and object oriented programming fragments.

10. A method of creating a fraud detection rule compliant pseudonymous identity for an anonymous or pseudonymous payment card comprising the steps of:
a) associating street numbers to a set of index numbers, generating a random number, and matching the random number to a street number index number to recover a street number;
b) associating street names numbers to a first set of index numbers, generating a first random number, and matching the random number to a street name index number to recover a street name;
c) associating city/state/ZIP code sets to a second set of index numbers, generating a second random number, and matching the random number to a city/state/ZIP code index number to recover a street number;
d) associating telephone numbers to a third set of index numbers, generating a third random number, and matching the random number to a telephone number; and
e) combining the recovered telephone number, street number, street, and city/state/ZIP set to generate a pseudonymous or anonymous card holder address and telephone number.

11. A method of creating a pseudonymous identity for a holder of a prepaid payment card associated with an entity, comprising the steps of:
a) concatenating a first alphanumeric associated with the entity with a second alphanumeric associated with a user; and
b) recording an address and telephone and telephone number associated with the user or the entity.

12. The method of claim 11 wherein the alphanumeric associated with the user is a sub-entity associated alphanumeric.

13. The method of claim 11 wherein the alphanumeric associated with the user is an employee associated alphanumeric.

14. The method of claim 11 wherein the step of concatenating a first alphanumeric associated with the entity with a second alphanumeric associated with a user further includes concatenating an alphanumeric associated with the sequence of the card assigned.

15. A method of aggregating funds into a prepaid payment card account comprising:
a) identifying a prepaid payment card account to receive the aggregated funds;
b) establishing an identity for an account holder of the identified prepaid payment card account;
c) establishing access authorization for payments into the prepaid payment card account; and
d) receiving payments into the prepaid payment card account.

16. The method of claim 15 wherein the identity of the account holder is chosen from the group consisting of a real, an anonymous, and a pseudonymous identity.

17. The method of claim 12 wherein establishing access authorization for payments into the prepaid payment card account comprises assigning a user id and a personal identification number.

18. The method of claim 14 wherein the user ID is a BIN within a set of BINs supported by a sponsor of the prepaid payment card.

19. The method of claim 14 wherein the user ID is selected by the owner of the prepaid payment card.

20. The method of claim 12 wherein a solicitor solicits payments to the prepaid payment card and the solicitation contains a hypertext link authorization payment access.

21. The method of claim 12 wherein a prepaid payment card account owner selects his or her own account, and transfers money from his or her other prepaid payment cards into the selected account.

22. A system for aggregation of funds into a prepaid payment account comprising a data server enters and recovers account data, an application server receives user input and output, and a database management system stores account data, wherein said system is controlled and configured to receive payments, match payment transfer information to existing accounts, and credit payment to the identified account.

23. The system of claim 22 further including a web server for receiving payments over the web.

24. The system of claim 22 wherein the system further includes a computer telephony integration facility.

25. A method of targeting advertising to owners of prepaid payment cards comprising querying a servicing bank's database for accounts having available credit, associating the accounts having available credit to account owners, ranking the accounts by at least one of amount of available credit, buying history, and expressed interests, and sending promotional advertising to account owners based upon available credit.

26. The method of claim 25 comprising sending the promotional advertising by e-mail.

27. The method of claim 25 comprising sending the promotional advertising as an advertising banner or icon on the sponsor's web page.

28. A method of rewarding users of payment cards participating in multiple promotional activities comprising searching a database associated to the payment cards and containing purchase history data, assigning a value to qualifying purchases at participating merchants, where there may be more then one participating merchant, and applying the assigned value to an account associated with the payment card.

29. The method of claim 28 wherein the payment card is a prepaid payment card.

30. The method of claim 28 comprising dynamically starting and stopping merchant participation in the campaign.

31. The method of claim 28 comprising collectively aggregating all assigned values to an account.

32. The method of claim 28 comprising individually storing assigned values identified to an individual merchant.

33. A system for rewarding users of payment cards participating in multiple promotional activities the system comprising an application server for managing account data and promotional data, a database server for managing account data, and one or more databases for storing account and promotional data, said one or more databases having data entries associated to a payment card, including individual merchant transactions, dates of the individual merchant transactions, and amounts of the individual merchant transactions, said system controlled and configured to search the database associated to the payment cards and containing purchase history data, assign values to qualifying purchases at one or more participating merchants, and apply the assigned value to an account associated with the payment card.

34. The system of claim 33 wherein the system is configured to controlled to collectively aggregate in a database all assigned values to an account.

35. The system of claim 33 wherein the system is configured and controlled to individually store in a database assigned values identified to an individual merchant.

36. A method of electronic person-to-person electronic payment comprising the steps of:
a) a payer electronically identifies a payee, and a source account of the funds to a payment card sponsor;
b) a sponsor sending a message fragment associated to the source account and identifying the payer, the payee, and the amount to be paid; and
c) a payee using the message fragment to request payment from the payment card sponsor.

37. The method of claim 36 wherein the source account is associated to a payment card.

38. The method of claim 37 wherein the payment card is a prepaid payment card.

39. The method of claim 36 wherein the message fragment is a hypertext link.

40. The method of claim 39 wherein the payee links to the hypertext link and receives payment or payment instructions.

41. The method of claim 36 wherein the message fragment is an encrypted association to the source account and the amount to be paid.

42. A system for person to person payment comprising a web server, an application server, and a database, said system configured and controlled to
a) receive at the web server an electronic request for payment to a payee, from a source account of the funds associated to the payer;
b) send a message fragment from the application server through the web server identifying the source account, the payer, the payee, and the amount to be paid;
c) receive a response at the application server to the message fragment from the payee; and
d) issue payment to the payee.
